(19) United States
(12) Patent Application Publication
(10) Pub. No.: US 2025/0284518 A1
(43) Pub. Date: Sep. 11, 2025

(54) STORAGE DEVICE AND METHOD PERFORMED BY THE SAME

(71) Applicant: Samsung Electronics Co., Ltd., Suwon-si (KR)

(72) Inventor: Yafei WANG, Suwon-si (KR)

(73) Assignee: Samsung Electronics Co., Ltd., Suwon-si (KR)

(21) Appl. No.: 18/632,812

(22) Filed: Apr. 11, 2024

(30) Foreign Application Priority Data
Mar. 11, 2024 (CN) 202410276885.1

(51) Int. Cl. G06F 9/455

(52) U.S. Cl. CPC G06F 9/45558; G06F 2009/45579

(57) ABSTRACT

A storage device and a method performed by the same are provided in the present disclosure, the storage device including: a memory comprising a plurality of virtual function (VF) apparatuses; a controller configured to: initialize a bandwidth credit of a VF queue corresponding to each VF apparatus of the plurality of VF apparatuses; and control reading of an I/O command from the VF queue corresponding to each VF apparatus, based on the bandwidth credit and data size of the I/O command.

### CROSS-REFERENCE TO RELATED APPLICATION

This application is based on and claims priority under 35 U.S.C. § 119 to Chinese Patent Application No. 202410276885.1, filed on Mar. 11, 2024, the disclosure of which is incorporated by reference herein in its entirety.

### TECHNICAL FIELD

The present disclosure relates to the field of semiconductors and, more specifically, to a storage device, a method performed by the storage device, a storage system, a host storage system, a data center system, a computer readable storage medium and an electronic apparatus.

### BACKGROUND

In an SR-IOV (Single Root I/O Virtualization) based I/O virtualization architecture, a plurality of apparatuses may share a single storage device, for example, an SSD following the PCIe protocol. This physical PCIe apparatus (Physical Function, PF) may present a plurality of Virtual Function (Virtual Function, VF) apparatuses to a host, whereby a single PCIe storage apparatus may include a plurality of VF apparatuses, each of which may be connected directly to a virtual machine of the host. Although this approach may reduce the involvement of a virtual machine monitor in I/O operations and improve I/O performance of the virtual machine, in such an SR-IOV-based architecture, when the load of each VF apparatus is large, there may be competition for bandwidth among the VF apparatuses, and bandwidth resources will then be unevenly distributed, with some VF apparatuses grabbing more bandwidth resources which causes other VF apparatuses to occupy very little bandwidth. For these VF apparatuses with little bandwidth resources, quality of service cannot be guaranteed and user experience may be poor. However, an existing attempt to solve the uneven bandwidth distribution requires the addition of new hardware for detecting changes in bandwidth traffic and a speed limit for each VF apparatus. Although it is possible to ensure that each VF apparatus average bandwidth in the case of bandwidth competition, there is an increase in hardware costs and/or a potential waste of bandwidth resources.

### SUMMARY

According to an aspect of the present disclosure, there is provided a storage device, the storage device includes: a memory including a plurality of virtual function (VF) apparatuses; a controller configured to: initialize a bandwidth credit of a VF queue corresponding to each VF apparatus of the plurality of VF apparatuses; and control reading of an I/O command from the VF queue corresponding to each VF apparatus, based on the bandwidth credit and data size of the I/O command.

Alternatively, the controller is configured to initialize the bandwidth credit of the VF queue corresponding to each VF apparatus based on a capacity ratio of each VF apparatus occupying the memory.

Alternatively, the controller is configured to initialize the bandwidth credit of the VF queue corresponding to each VF apparatus based on the capacity ratio and a weight value (for example, predefined) for each VF apparatus.

Alternatively, the controller is configured to: poll each VF queue to read the I/O command from a non-empty VF queue with a current bandwidth credit greater than a threshold based on initializing the bandwidth credit of the VF queue corresponding to each VF apparatus; and in response to the I/O command being read out of the non-empty VF queue, update the current bandwidth credit of this VF queue by subtracting the data size of the read command from the current bandwidth credit of this VF queue, and in response to the updated current bandwidth credit of this VF queue being no longer greater than the threshold, stop reading of the I/O command from this VF queue.

Alternatively, the controller is further configured to: in response to each VF queue being polled once, determine whether current bandwidth credits of all VF queues are all less than or equal to the threshold; in response to the current bandwidth credits of all the VF queues all being less than or equal to the threshold, initialize the bandwidth credit of each VF queue again, otherwise continue to read the I/O command from the non-empty VF queue with the current bandwidth credit greater than the threshold.

Alternatively, the controller is further configured to: set the current bandwidth credit of a VF queue to the threshold if this VF queue is empty.

Alternatively, in response to the current bandwidth credits of all the VF queues being less than or equal to the threshold, the controller is configured to initialize the bandwidth credit of each VF queue again by adding the current bandwidth credit of each VF queue to a first initialized bandwidth credit of each VF queue.

According to another aspect of the present disclosure, there is provided a method performed by a storage device, wherein the storage device includes a memory, the memory including a plurality of virtual function (VF) apparatuses, the method including: initializing a bandwidth credit of a VF queue corresponding to each VF apparatus of the plurality of VF apparatuses; and controlling reading of an I/O command from the VF queue corresponding to each VF apparatus, based on the bandwidth credit and the data size of the I/O command.

Alternatively, the initializing the bandwidth credit of the VF queue corresponding to each VF apparatus of the plurality of VF apparatuses includes: initializing the bandwidth credit of the VF queue corresponding to each VF apparatus based on a capacity ratio of each VF apparatus occupying the memory.

Alternatively, the initializing the bandwidth credit of the VF queues corresponding to each VF apparatus based on the capacity ratio of each VF apparatus occupying the memory includes: initializing the bandwidth credit of the VF queue corresponding to each VF apparatus based on the capacity ratio and a weight value (for example, predefined) for each VF apparatus.

Alternatively, the controlling the reading of the I/O command from the VF queue corresponding to each VF apparatus based on the bandwidth credit and the data size of the I/O commands includes: polling each VF queue to read the I/O command from a non-empty VF queue with a current bandwidth credit greater than a threshold based on initializing the bandwidth credit of the VF queue corresponding to each VF apparatus; and in response to the I/O command being read out of the non-empty VF queue, updating the current bandwidth credit of this VF queue by subtracting the data size of the read command from the current bandwidth credit of this VF queue, and in response to the updated current bandwidth credit of this VF queue being no longer greater than the threshold, stopping reading of the I/O command from that VF queue.

Alternatively, the method further including: in response to each VF queue being polled once, determine whether current bandwidth credits of all VF queues are all less than or equal to the threshold; in response to the current bandwidth credits of all the VF queues all being less than or equal to the threshold, initializing the bandwidth credit of each VF queue again, otherwise continuing to read I/O commands from non-empty VF queues with the current bandwidth credit greater than the threshold.

Alternatively, the method further including: setting the current bandwidth credit of a VF queue to the threshold if this VF queue is empty.

Alternatively, the initializing the bandwidth credit of each VF queue again includes: initializing the bandwidth credit of each VF queue again by adding the current bandwidth credit of each VF queue to a first initialized bandwidth credit of each VF queue.

According to another aspect of the present disclosure, there is provided a storage system, the storage system includes: a main processor; a memory; and a storage device, wherein the storage device is configured to perform the method described above.

According to another aspect of the present disclosure, there is provided a host storage system, the host storage system includes: a host; and a storage device, wherein the storage device is configured to perform the method described above.

According to another aspect of the present disclosure, there is provided a data center system, the data center system includes: a plurality of application servers; and a plurality of storage servers, wherein each storage server includes a storage device, wherein the storage device is configured to perform the method described above.

According to another aspect of the present disclosure, there is provided a computer readable storage medium having a computer program stored thereon, wherein the method described above is implemented when the computer program is executed by a processor.

According to another aspect of the present disclosure, there is provided an electronic apparatus, the electronic apparatus includes: a processor; and a memory storing a computer program, the computer program, when executed by the processor, implementing the method described above.

According to the technical solutions provided by example embodiments of the present disclosure, dynamic bandwidth resource scheduling may be achieved, which not only enables balanced bandwidth distribution, but also avoids bandwidth wastage.

It should be understood that the above general description and the later detailed description are examples and explanatory only and do not limit the present disclosure.

### BRIEF DESCRIPTION OF THE DRAWINGS

The accompanying drawings herein are incorporated into and form part of the specification, illustrate example embodiments consistent with the present disclosure, which are used in conjunction with the specification to explain the principles of the present disclosure and do not constitute an undue limitation of the present disclosure.

FIG. 1 is a schematic diagram illustrating an SR-IOV-based I/O virtualization architecture;

FIG. 2 is a schematic diagram illustrating an SR-IOV-based I/O virtualization architecture with uneven bandwidth distribution due to I/O competition;

FIG. 3 is a schematic diagram of a device that attempts to achieve balanced bandwidth by adding hardware apparatuses;

FIG. 4 is a schematic diagram illustrating bandwidth wastage;

FIG. 5 is a flowchart illustrating a method performed by a storage device according to example embodiments of the present disclosure;

FIG. 6 is a flowchart illustrating an example of a method performed by a storage device;

FIG. 7 is a schematic diagram of applying the method according to example embodiments of the present disclosure to achieve balanced bandwidth distribution;

FIG. 8 is a schematic diagram of applying a method according to example embodiments of the present disclosure to avoid a waste of bandwidth resources;

FIG. 9 is a schematic diagram of the procedure of applying the method according to example embodiments of the present disclosure for dynamic scheduling of bandwidth resources when the load varies;

FIG. 10 illustrates a block diagram of a storage device according to example embodiments of the present disclosure;

FIG. 11 illustrates an example schematic diagram of a storage device according to example embodiments of the present disclosure;

FIG. 12 is a diagram of a system to which a storage device is applied according to example embodiments of the present disclosure;

FIG. 13 is a block diagram of a host storage system according to example embodiments;

FIG. 14 is a diagram of a data center to which a memory device is applied according to example embodiments of the present disclosure.

### DETAILED DESCRIPTION

In order to enable a person of ordinary skill in the art to better understand the technical solutions of the present disclosure, the technical solutions provide by example embodiments of the present disclosure will be clearly and completely described below in conjunction with the accompanying drawings.

It should be noted that the terms “first”, “second”, etc. in the specification and claims of the present disclosure and the accompanying drawings above are used to distinguish similar objects rather than to describe a particular order or sequence. It should be understood that data so distinguished may be interchanged, where appropriate, so that example embodiments of the present disclosure described herein may be implemented in an order other than those illustrated or described herein. Example embodiments described in the following examples do not represent all example embodiments that are consistent with the present disclosure. Rather, they are only examples of devices and methods that are consistent with some aspects of the present disclosure, as detailed in the appended claims.

It should be noted herein that “at least one of the several items” in this present disclosure includes “any one of the several items”, “any combination of the several items” and “all of the several items” the juxtaposition of these three categories. For example, “including at least one of A and B” includes the following three juxtapositions: (1) including A; (2) including B; (3) including A and B. Another example is “performing at least one of operation one and operation two”, which means the following three juxtapositions (1) performing operation one; (2) performing operation two; (3) performing operation one and operation two.

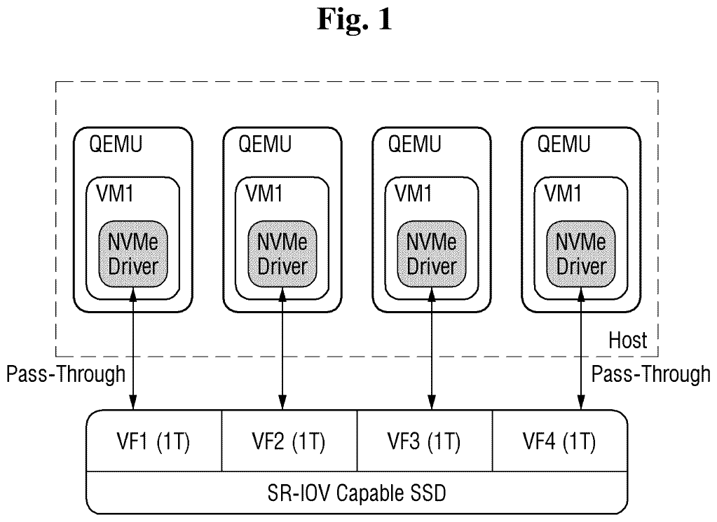

For example, an SR-IOV (Single Root I/O Virtualization) based I/O virtualization architecture may have a case of uneven distribution of bandwidth resources. FIG. 1 is a schematic diagram illustrating an SR-IOV-based I/O virtualization architecture. As shown in FIG. 1, a host includes a plurality of virtual machines (VMs), e.g., VM1, VM2, VM3 and VM4, each VM with its own NVMe driver, and a quick emulator (QEMU) for booting the VM. A storage device (e.g., SR-IOV capable SSD) may include four VF apparatuses, namely VF1, VF2, VF3 and VF4 respectively. Each VF apparatus corresponds to a VF queue, which contains I/O commands passed from the corresponding NVMe driver. A controller in the storage device may read the I/O command from each VF queue to read and write data. The reading of the I/O command from the VF queue corresponding to each VF apparatus consumes the corresponding bandwidth resources. Assuming a capacity of 4 T for the entire SSD, each VF may have a capacity of 1 T respectively. Although the capacity of each VF is the same in the example of FIG. 1, the capacity of each VF may also be uneven. Each VF may be passed-through to the virtual machine via a pass-through method, which reduces the involvement of a virtual machine monitor in I/O operations and improves I/O performance of the virtual machine. However, in such an SR-IOV-based architecture, when load of each VF apparatus is large, there may be competition for bandwidth among the VF apparatuses, and bandwidth resources may be then unevenly distributed.

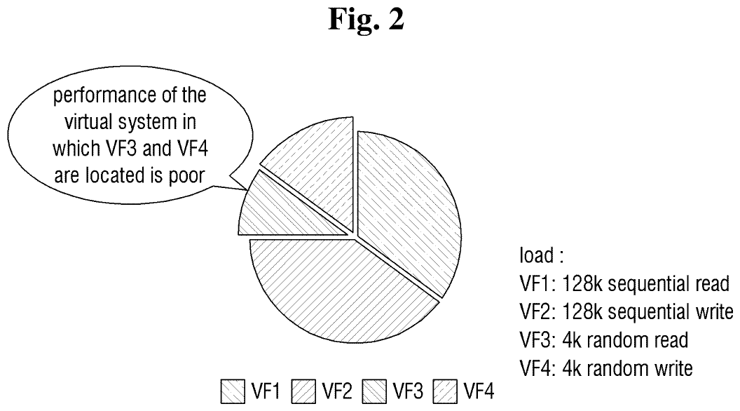

FIG. 2 a schematic diagram illustrating an SR-IOV-based I/O virtualization architecture with uneven bandwidth distribution due to I/O competition. As shown in FIG. 2, with the load of VF1 and VF2 being 128k sequential read and 128k sequential write respectively, and VF3 and VF4 being 4k random read and 4k random read write respectively, VF1 and VF2 may grab more bandwidth resources which may cause VF3 and VF4 to occupy very little bandwidth resources, resulting in poorer performance of the virtual system in which VF3 and VF4 are located, nonguaranteed quality of service and/or poorer user experience.

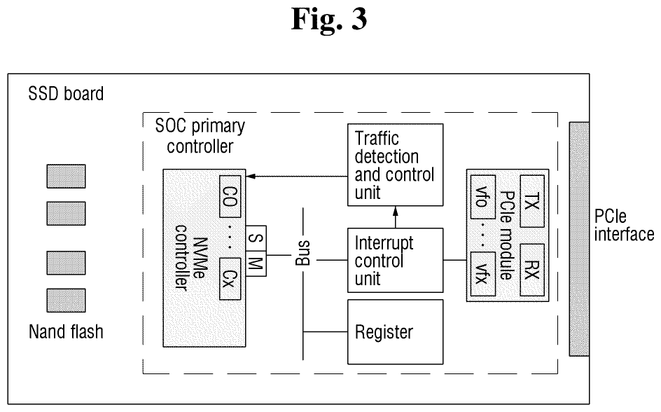

FIG. 3 is a schematic diagram of a device that attempts to achieve balanced bandwidth by adding hardware apparatuses. As shown in FIG. 3, following hardware modules are added to a device that attempts to achieve balanced bandwidth by adding dedicated hardware apparatus to an existing apparatus: an SSD traffic detection and control unit, which calculates the bandwidth of each controller using data transmission information on bus, and implements speed limit screening and signaling according to the bandwidth ratio set in a traffic control register; an interrupt control unit, which is used to transform the speed limit signal from the traffic control module into an interrupt, and transmit to a CPU core. In this way, the hardware modules may calculate the bandwidth of each controller and, together with the CPU firmware, implement bandwidth constraint function of the virtual apparatus. However, not only does this approach increase the hardware cost, but also this bandwidth constraint approach, although may achieve, by limiting the speed of each VF apparatus, the goal of ensuring that each VF apparatus gets an average bandwidth in case of bandwidth competition without certain VF having poor performance, as to the case of some VFs with large load and some VFs with small load, even if there is unoccupied bandwidth, the VFs with large load cannot use the unoccupied bandwidth due to the speed limit, resulting in a waste of bandwidth resources. The reason is that in existing bandwidth limiting schemes, I/O commands are usually read from VF queues by polling the I/O commands among VF queues according to the number of commands, e.g., the maximum number of commands allowed to be read from each VF queue is set uniformly and if the threshold of the number of commands for each VF queue is exceeded, the I/O command is no longer read from that VF queue. However, such a read approach may result in uneven bandwidth distribution and a waste of bandwidth resources.

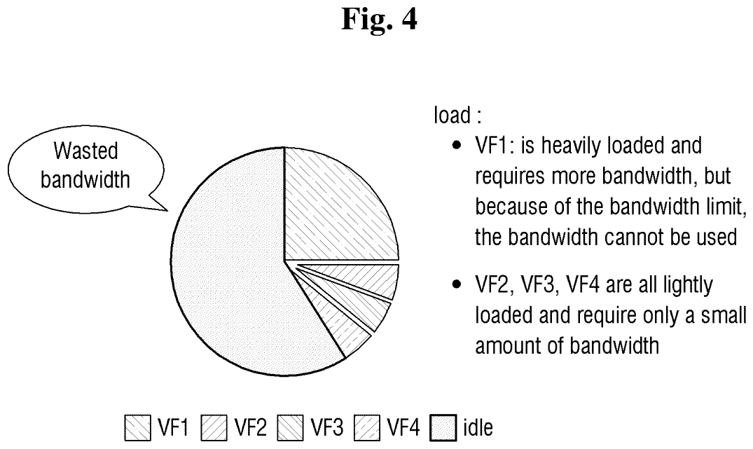

FIG. 4 is a schematic diagram illustrating the bandwidth wastage. As shown in FIG. 4, VF2, VF3 and VF4 are all lightly loaded and require only a small amount of bandwidth, while VF1 is heavily loaded and requires more bandwidth, but because of the bandwidth limit, even if there is unoccupied bandwidth, VF1 cannot use the unoccupied bandwidth, thus resulting in a waste of bandwidth resources.

To address this, the present disclosure proposes a conception for dynamic scheduling of bandwidth considering the bandwidth limit and data size of I/O command to avoid the above problem.

In the following, a storage device and a method performed by the storage device according to the conception of the inventive concepts are described.

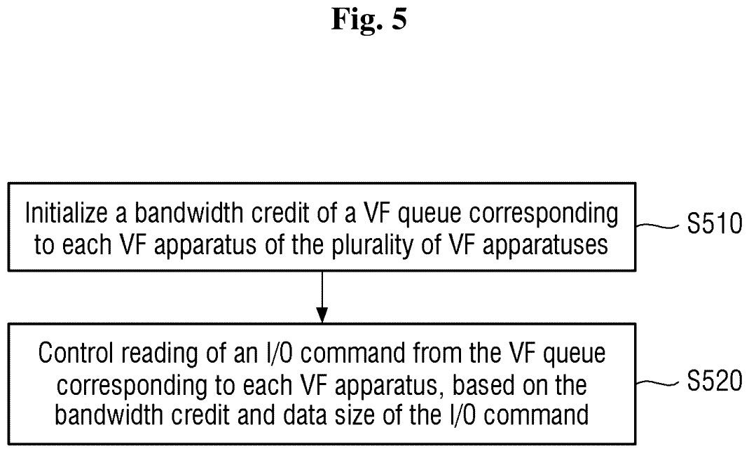

FIG. 5 is a flowchart illustrating a method performed by a storage device according to example embodiments of the present disclosure. According to example embodiments, the storage device may include a memory, and the memory may include a plurality of VF apparatuses. For example, the storage device may be an SSD. Referring to FIG. 5, in operation S510, a bandwidth credit of a VF queue corresponding to each VF apparatus of the plurality of VF apparatuses may be initialized. According to example embodiments, the bandwidth credit of the VF queue corresponding to each VF apparatus may be initialized based on a capacity ratio of each VF apparatus occupying the memory. For example, if a capacity of the storage device is 4 T and a capacity of each VF apparatus is 1 T, the bandwidth credit of each VF queue may be 25% of total bandwidth. Alternatively, it is also possible to define weight values for each VF based on the user's own requirements and then, initialize the bandwidth credits of the VF queues in combination with the weight values. That is, alternatively, the bandwidth credit of the VF queue corresponding to each VF apparatus may be initialized based on the capacity ratio and the weight value (for example, predefined) for each VF apparatus. For example, in the case that a threshold value of bandwidth b (e.g. 25% of the total bandwidth) is set for each VF apparatus according to the capacity ratio, the user is allowed to set a weight w for each VF apparatus according to its own requirements, for example, when a user requires high bandwidth but less capacity for a certain VF apparatus, a value of w greater than 1 may be set to enable that VF apparatus to obtain a higher bandwidth. In this way, the bandwidth credit of the VF queue corresponding to each VF apparatus may be set in a more personalized way. As an example, the method of setting the weight w may be through the Set Features command or the Vendor Specific command in the NVMe standard, by which the weight of each VF apparatus may be set. The set threshold b and weight w may be stored in the storage device in the form of a table to be used during initialization. For example, the bandwidth credit of the VF queue corresponding to each VF apparatus may be set to be the product of b and w. It should be noted that the way of initializing the bandwidth credit of the VF queue corresponding to each VF apparatus of the inventive concepts is not limited to the above example, but may also be other ways of initializing, for example, directly defining the bandwidth credit of each VF queue by the user.

After setting the bandwidth credit of the VF queue corresponding to each VF apparatus, in operation S520, reading of an I/O command from the VF queue corresponding to each VF apparatus is controlled, based on the bandwidth credit and data size of the I/O command. By considering the bandwidth credit of each VF queue when controlling the reading of the I/O command from the VF queue corresponding to each VF apparatus, uneven bandwidth distribution due to competition for bandwidth resources may be effectively avoided, however, if only the bandwidth credit is considered for command reading control, it may lead to a waste of bandwidth resources. Therefore, the inventive concepts further consider the data size of the I/O command and combines it with the bandwidth credit to jointly control the reading of the I/O command from the VF queue corresponding to each VF apparatus, thereby avoiding both uneven bandwidth distribution and the waste of bandwidth resources, and achieving better dynamic bandwidth scheduling.

For example, according to example embodiments, operation S520 may include: polling each VF queue to read the I/O command from a non-empty VF queue with a current bandwidth credit greater than a (for example, preset) threshold based on initializing the bandwidth credit of the VF queue corresponding to each VF apparatus; and in response to the I/O command being read out of the non-empty VF queue, updating the current bandwidth credit of this VF queue by subtracting the data size of the read command from the current bandwidth credit of this VF queue, and in response to the updated current bandwidth credit of this VF queue being no longer greater than the (for example, preset) threshold, stopping reading of the I/O command from that VF queue. For example, the (for example, preset) threshold may be 0, but is not limited thereto. For example, the bandwidth credit of each VF queue may be initialized to credit=w*b, and every time when each command is read out in one VF queue, the data size of the read command is subtracted from the bandwidth credit, and when the current bandwidth credit of one VF queue is less than or equal to 0, no more commands will be read from this VF queue.

Further, alternatively, the method shown in FIG. 5 may further include: in response to each VF queue being polled once, determining whether current bandwidth credits of all VF queues are all less than or equal to the (for example, preset) threshold; and in response to the current bandwidth credits of all the VF queues all being less than or equal to the (for example, preset) threshold, initializing the bandwidth credit of each VF queue again, otherwise continuing to read the I/O command from the non-empty VF queue with the current bandwidth credit greater than the (for example, preset) threshold. For example, when the credits of all queues are less than or equal to 0, the credits are initialized again and a new round of command reading begins, so that a dynamic balance of bandwidth may be achieved within a cycle (here, the cycle is the time period for the consumption of the bandwidth credits of all queues from the initial value to less than or equal to 0). According to example embodiments, the initializing the bandwidth credit of each VF queue again includes: initializing the bandwidth credit of each VF queue again by adding the current bandwidth credit of each VF queue to a first initialized bandwidth credit of each VF queue.

The method shown in FIG. 5 may further include: setting the current bandwidth credit of a VF queue to the (for example, preset) threshold if this VF queue is empty. Since the I/O command is only read from the non-empty VF queue with the current bandwidth credit greater than the (for example, preset) threshold, after the current bandwidth credit of this VF queue is set to the (for example, preset) threshold, no more commands will be fetched from that queue, and the bandwidth of that queue may be given up for use by other queues in need, thus effectively avoiding a waste of bandwidth resources. For example, when a certain queue which is empty is polled, the credit of that queue will be set to 0, so that the bandwidth given up by that queue may be used by other queues in need, realizing dynamic scheduling of bandwidth resources.

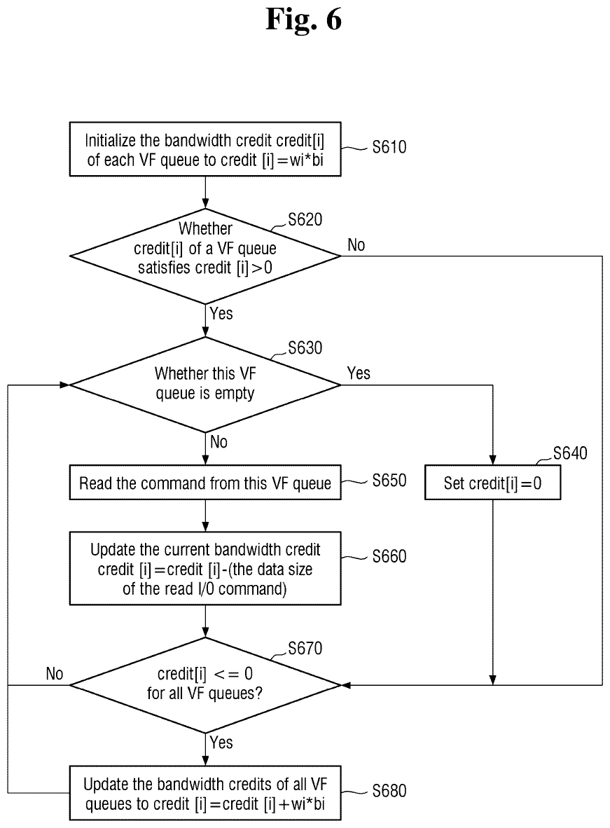

FIG. 6 is a flowchart illustrating an example of a method performed by a storage device. As shown in FIG. 6, in operation S610, the bandwidth credit credit[i] of each VF queue is initialized to credit[i]=wi*bi, wherein wi is a weight of the ith VF apparatus of the plurality of VF apparatuses, respectively, and bi is a bandwidth limit of the ith VF queue corresponding to the ith VF apparatus. Next, in operation S620, it is determined whether credit[i] of each VF queue satisfies credit[i]>0. If credit[i]>0 is satisfied, then in operation S630, it is determined whether this VF queue is empty. If credit[i]>0 is not satisfied, proceed to operation S670. If this VF queue is empty, then in operation S640, the current bandwidth credit of this queue is set to 0, e.g. credit[i]=0. If this VF queue is not empty, then in operation S650, the command is read from this VF queue and in operation S660, the current bandwidth credit is updated credit[i]=credit[i]−(the data size of the read I/O command). After updating the bandwidth credit, proceed to operation S670. In operation S670, if credit[i]<=0 for all VF queues are checked. If no, return to perform operation S620. If yes, the bandwidth credits for all VF queues are initialized again. For example, in operation S680, the bandwidth credits of all VF queues may be initialized again by updating them to credit[i]=credit[i]+wi*bi and then continue with operation S620.

The above method according to example embodiments of the present disclosure enables dynamic bandwidth resource scheduling, which not only achieves balanced bandwidth distribution but also avoids bandwidth wastage. The above method also does require adding may also be provided by a dedicated hardware, for example, an SSD traffic detection control unit, traffic control register, and/or an interrupt control unit.

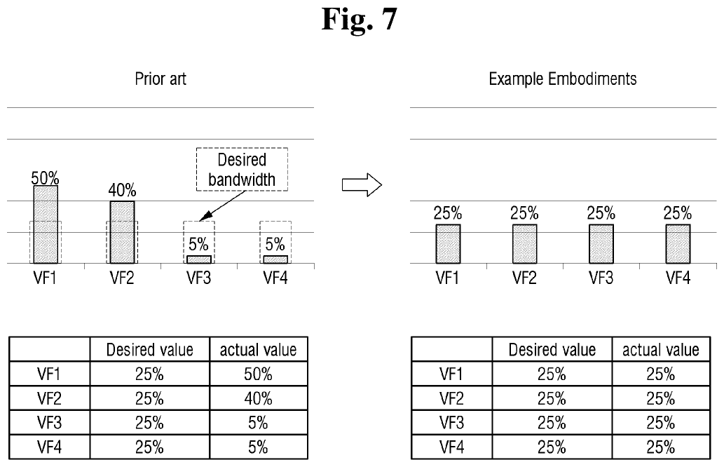

FIG. 7 is a schematic diagram of applying the method according to example embodiments of the present disclosure to achieve balanced bandwidth distribution. In the case of each VF apparatus with heavy load, there will be competition for bandwidth resources, and certain VF apparatuses compete to obtain more resources while certain VF apparatuses become poorly performing and unable to ensure quality of service as a result, however, by applying the above method according to example embodiments of the present disclosure, each VF apparatus has a limit of the bandwidth credit that cannot be exceeded, which ensures that each VF obtains its respective deserved bandwidth in the case of competition for bandwidth. For example, as shown in FIG. 7, it is assumed that the desired bandwidth of VF1, VF2, VF3 and VF4 is all 25% of the total bandwidth, however, due to competition for bandwidth resources, the actual bandwidth obtained by VF1, VF2, VF3 and VF4 may be 50%, 40%, 5% and 5% respectively. However, after applying the above method according to example embodiments of the present disclosure, ideally, each VF apparatus may obtain approximately 25% of the bandwidth and balanced distribution of bandwidth resources may be substantially achieved.

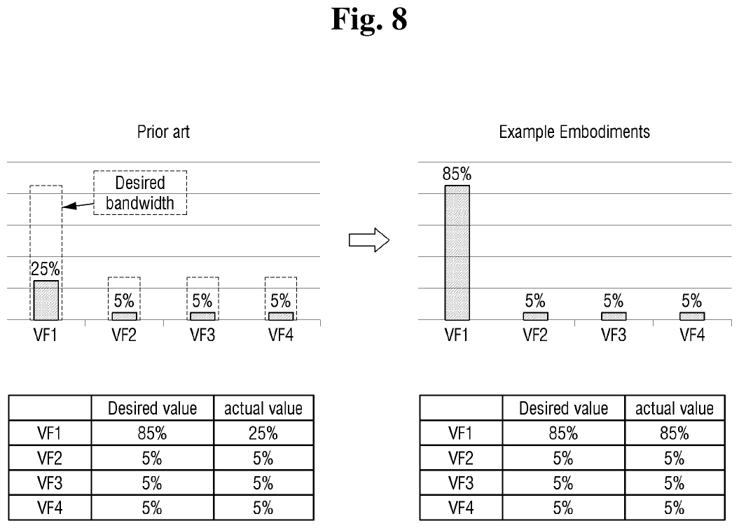

FIG. 8 is a schematic diagram of applying a method according to example embodiments of the present disclosure to avoid a waste of bandwidth resources.

As mentioned above, it may lead to a waste of bandwidth resources that the speed of VF apparatuses with high bandwidth demand is limited even when some of the VF apparatuses are relatively idle. For example, as shown in FIG. 8, it is supposed that VF1 is heavily loaded and its desired bandwidth is 85% of the total bandwidth, and VF2, VF3 and VF4 all have a desired bandwidth of 5%. However, when VF2, VF3 and VF4 are relatively idle, according to the existing command reading method, even if VF2, VF3 and VF4 have unoccupied bandwidth, VF1 cannot use the unoccupied bandwidth, thereby causing a waste of bandwidth. However, according to the above method of example embodiments of the present disclosure, by assigning a bandwidth credit to each VF queue and decreasing the credit according to the data size of each fetched command, when the queue is empty, the credit of the queue is directly set to 0, so that the bandwidth of the idle queue may be given out for use by other queues in need. As shown in FIG. 8, the desired bandwidth of each VF may ideally be satisfied according to the above method of example embodiments of the present disclosure.

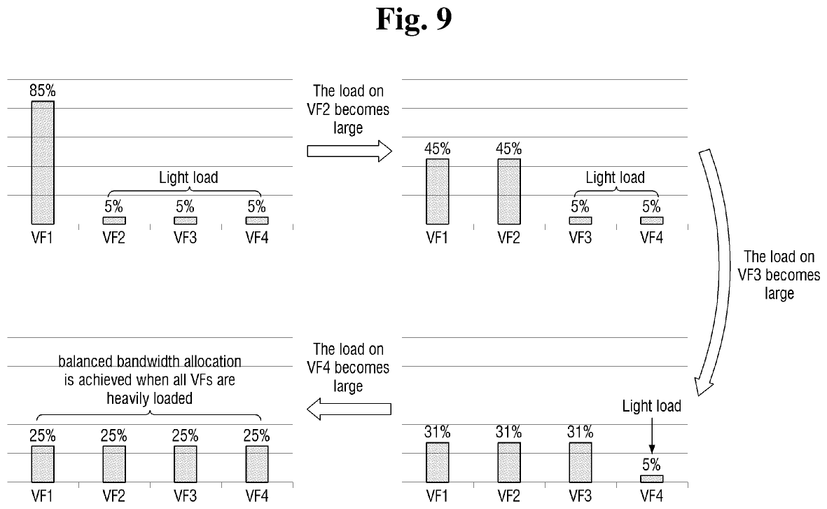

FIG. 9 is a schematic diagram of the procedure of applying the method according to example embodiments of the present disclosure for dynamic scheduling of bandwidth resources when the load varies.

In a practical traffic scenario, load on the individual VFs is dynamically changing, and the load may be small at first, and there may be a sudden increase in load, for example, as shown in FIG. 9, initially only the load on VF1 is large and the load on VF2, VF3, and VF4 are all small, at this moment, according to the above method of example embodiments of the present disclosure, VF1 may use the bandwidth given up by idle VFs (e.g., VF2, VF3 and VF4). Then, the load on VF2 suddenly becomes large due to traffic demand, and according to the above method of example embodiments of the present disclosure, all available bandwidth may be dynamically allocated to the two VFs (e.g., VF1 and VF2) in need in a balanced manner. Then, as the traffic changes, a larger load is gradually generated on VF3 and VF4, and finally, in the case that all VFs need to grab the bandwidth, the bandwidth may be allocated to the four VFs in a balanced manner according to the above method of example embodiments of the present disclosure.

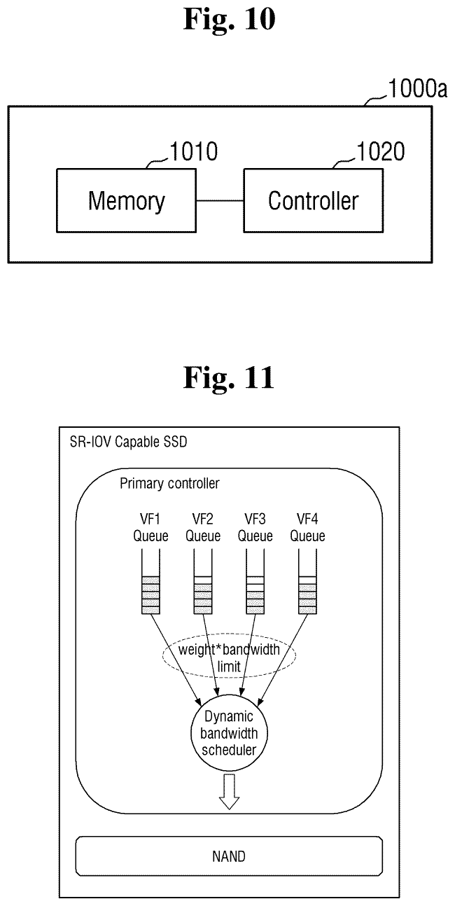

Hereinafter, the storage device according to example embodiments of the present disclosure is described with reference to FIG. 10 and FIG. 11. FIG. 10 illustrates a block diagram of a storage device according to example embodiments of the present disclosure.

Referring to FIG. 10, the storage device 1000a includes a memory 1010 and a controller 1020. The memory 1010 may include a plurality of virtual function (VF) devices. The controller 1020 may be configured to: initialize a bandwidth credit of a VF queue corresponding to each VF apparatus of the plurality of VF apparatuses; and control reading of an I/O command from the VF queue corresponding to each VF apparatus, based on the bandwidth credit and data size of the I/O command.

For example, according to example embodiments, the controller 1020 may be configured to initialize the bandwidth credit of the VF queue corresponding to each VF apparatus based on a capacity ratio of each VF apparatus occupying the memory 1010. Alternatively, the controller 1020 may be configured to initialize the bandwidth credit of the VF queue corresponding to each VF apparatus based on the capacity ratio and a weight value (for example, predefined) for each VF apparatus.

Further, according to example embodiments, the controller 1020 may be configured to: poll each VF queue to read the I/O command from a non-empty VF queue with a current bandwidth credit greater than a (for example, preset) threshold based on initializing the bandwidth credit of the VF queue corresponding to each VF apparatus; and in response to the I/O command being read out of the non-empty VF queue, update the current bandwidth credit of this VF queue by subtracting the data size of the read command from the current bandwidth credit of this VF queue, and in response to the updated current bandwidth credit of this VF queue being no longer greater than the (for example, preset) threshold, stop reading of the I/O command from this VF queue.

Alternatively, according to example embodiments, the controller 1020 may further be configured to: in response to each VF queue being polled once, determine whether current bandwidth credits of all VF queues are all less than or equal to the (for example, preset) threshold; in response to the current bandwidth credits of all the VF queues all being less than or equal to the (for example, preset) threshold, initialize the bandwidth credit of each VF queue again, otherwise continue to read the I/O command from the non-empty VF queue with the current bandwidth credit greater than the (for example, preset) threshold. For example, when the current bandwidth credits of all the VF queues are less than or equal to the (for example, preset) threshold, the controller 1020 initializes the bandwidth credit of each VF queue again by adding the current bandwidth credit of each VF queue to a first initialized bandwidth credit of each VF queue. Alternatively, according to example embodiments, the controller 1020 may also be configured to set the current bandwidth credit of a VF queue to the (for example, preset) threshold if this VF queue is empty.

FIG. 11 illustrates an example schematic diagram of a storage device according to example embodiments of the present disclosure. As shown in FIG. 11, the storage device 1000a may be an SSD, e.g., an SR-IOV capable SSD. For example, the memory 1010 included in storage device 1000a may be an array of NAND chips. A plurality of VF apparatuses may be included in the array of NAND chips. The controller 1020 included in the storage device 1000a may be a primary controller in the SSD. The primary controller may include a dynamic bandwidth scheduler module which may be configured to perform the operations mentioned above which are performed by the controller 1010. For example, this dynamic bandwidth scheduler module may initialize the bandwidth credit of the VF queue corresponding to each VF apparatus of the plurality of VF apparatuses, for example, initializing the bandwidth credit of each VF queue to the weight*the bandwidth limit. This dynamic bandwidth scheduler module may then control the reading of I/O command from the VF queues corresponding to each VF apparatus based on the bandwidth credit and the data size of the I/O commands, thereby enabling dynamic bandwidth scheduling.

The storage device according to example embodiments of the present disclosure may achieve dynamic bandwidth resource scheduling, which not only achieves a balanced bandwidth distribution, but also avoids bandwidth wastage.

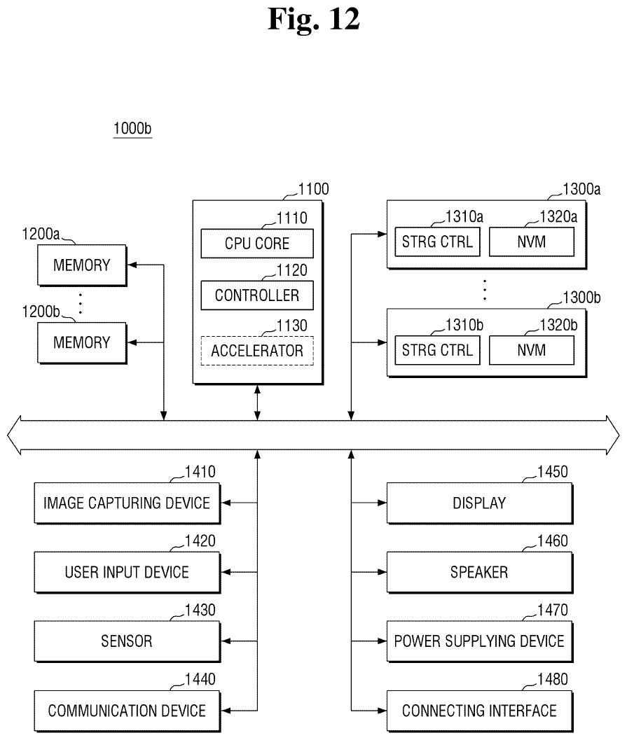

FIG. 12 is a diagram of a system 1000b to which a storage device is applied, according to example embodiments of the present disclosure.

The system 1000b of FIG. 12 may basically be a mobile system, such as a portable communication terminal (e.g., a mobile phone), a smartphone, a tablet personal computer (PC), a wearable device, a healthcare device, or an Internet of things (IOT) device. However, the system 1000b of FIG. 12 is not necessarily limited to a mobile system and may be a PC, a laptop computer, a server, a media player, or an automotive device (e.g., a navigation device).

Referring to FIG. 12, the system 1000b may include a main processor 1100, memories (e.g., 1200a and 1200b), and storage devices (e.g., 1300a and 1300b). The storage devices may be configured to perform the data access method described above. The system 1000b may include at least one of an image capturing device 1410, a user input device 1420, a sensor 1430, a communication device 1440, a display 1450, a speaker 1460, a power supplying device 1470, and a connecting interface 1480.

The main processor 1100 may control all operations of the system 1000b, for example, operations of other components included in the system 1000b. The main processor 1100 may be implemented as a general-purpose processor, a dedicated processor, or an application processor.

The main processor 1100 may include at least one CPU core 1110 and further include a controller 1120 configured to control the memories 1200a and 1200b and/or the storage devices 1300a and 1300b. In some example embodiments, the main processor 1100 may further include an accelerator 1130, which is a dedicated circuit for a high-speed data operation, such as an artificial intelligence (AI) data operation. The accelerator 1130 may include a graphics processing unit (GPU), a neural processing unit (NPU) and/or a data processing unit (DPU) and be implemented as a chip that is physically separate from the other components of the main processor 1100.

The accelerator 1130 may, for example, have a structure that is trainable, e.g., with training data, such as an artificial neural network, a decision tree, a support vector machine, a Bayesian network, a genetic algorithm, and/or the like. Non-limiting examples of the trainable structure may include a convolution neural network (CNN), a generative adversarial network (GAN), an artificial neural network (ANN), a region based convolution neural network (R-CNN), a region proposal network (RPN), a recurrent neural network (RNN), a stacking-based deep neural network (S-DNN), a state-space dynamic neural network (S-SDNN), a deconvolution network, a deep belief network (DBN), a restricted Boltzmann machine (RBM), a fully convolutional network, a long short-term memory (LSTM) network, a classification network, and/or the like.

The memories 1200a and 1200b may be used as main memory devices of the system 1000b. Although each of the memories 1200a and 1200b may include a volatile memory, such as static random access memory (SRAM) and/or dynamic RAM (DRAM), each of the memories 1200a and 1200b may include non-volatile memory, such as a flash memory, phase-change RAM (PRAM) and/or resistive RAM (RRAM). The memories 1200a and 1200b may be implemented in the same package as the main processor 1100.

The storage devices 1300a and 1300b may serve as non-volatile storage devices configured to store data regardless of whether power is supplied thereto, and have larger storage capacity than the memories 1200a and 1200b. The storage devices 1300a and 1300b may respectively include storage controllers (STRG CTRL) 1310a and 1310b and NVMs (Non-Volatile Memories) 1320a and 1320b configured to store data via the control of the storage controllers 1310a and 1310b. Although the NVMs 1320a and 1320b may include flash memories having a two-dimensional (2D) structure or a three-dimensional (3D) V-NAND structure, the NVMs 1320a and 1320b may include other types of NVMs, such as PRAM and/or RRAM.

The storage devices 1300a and 1300b may be physically separated from the main processor 1100 and included in the system 1000b or implemented in the same package as the main processor 1100. The storage devices 1300a and 1300b may have types of solid-state devices (SSDs) or memory cards and be removably combined with other components of the system 100 through an interface, such as the connecting interface 1480 that will be described below. The storage devices 1300a and 1300b may be devices to which a standard protocol, such as a universal flash storage (UFS), an embedded multi-media card (eMMC), or a non-volatile memory express (NVMe), is applied, without being limited thereto.

The image capturing device 1410 may capture still images or moving images. The image capturing device 1410 may include a camera, a camcorder, and/or a webcam.

The user input device 1420 may receive various types of data input by a user of the system 1000b and include a touch pad, a keypad, a keyboard, a mouse, and/or a microphone.

The sensor 1430 may detect various types of physical quantities, which may be obtained from the outside of the system 1000b, and convert the detected physical quantities into electric signals. The sensor 1430 may include a temperature sensor, a pressure sensor, an illuminance sensor, a position sensor, an acceleration sensor, a biosensor, and/or a gyroscope sensor.

The communication device 1440 may transmit and receive signals between other devices outside the system 1000b according to various communication protocols. The communication device 1440 may include an antenna, a transceiver, and/or a modem.

The display 1450 and the speaker 1460 may serve as output devices configured to respectively output visual information and auditory information to the user of the system 1000b.

The power supplying device 1470 may appropriately convert power supplied from a battery (not shown) embedded in the system 1000b and/or an external power source, and supply the converted power to each of components of the system 1000b.

The connecting interface 1480 may provide connection between the system 1000b and an external device, which is connected to the system 1000b and capable of transmitting and receiving data to and from the system 1000b. The connecting interface 1480 may be implemented by using various interface schemes, such as advanced technology attachment (ATA), serial ATA (SATA), external SATA (e-SATA), small computer small interface (SCSI), serial attached SCSI (SAS), peripheral component interconnection (PCI), PCI express (PCIe), NVMe, IEEE 1394, a universal serial bus (USB) interface, a secure digital (SD) card interface, a multi-media card (MMC) interface, an eMMC interface, a UFS interface, an embedded UFS (eUFS) interface, and a compact flash (CF) card interface.

The storage device (e.g., 1300a or 1300b) may be a solid state drive (SSD). According to example embodiments of the present disclosure, a system (e.g., 1000b), to which a storage device is applied, is provided, including: a main processor (e.g., 1100); a memory (e.g., 1200a and 1200b); and the storage device (e.g., 1300a and 1300b), wherein the storage device is configured to perform the method according to example embodiments of the present disclosure as described above.

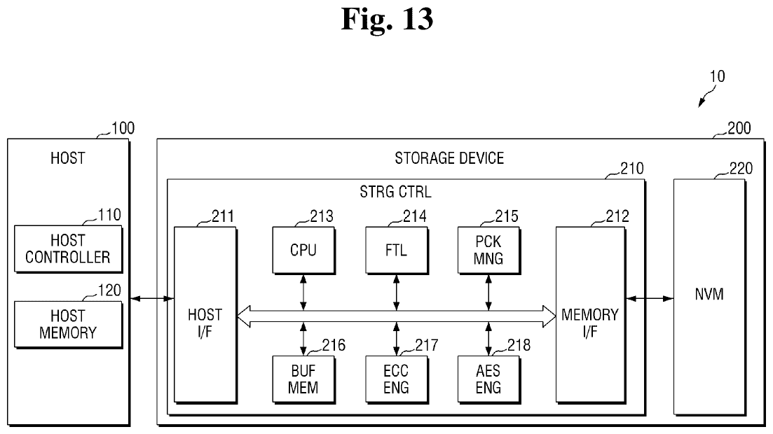

FIG. 13 is a block diagram of a host storage system 10 according to example embodiments.

The host storage system 10 may include a host 100 and a storage device 200. The storage device 200 may be configured to perform the data access method described above. Further, the storage device 200 may include a storage controller 210 and an NVM 220. According to example embodiments, the host 100 may include a host controller 110 and a host memory 120. The host memory 120 may serve as a buffer memory configured to temporarily store data to be transmitted to the storage device 200 or data received from the storage device 200.

The storage device 200 may include storage media configured to store data in response to requests from the host 100. As an example, the storage device 200 may include at least one of an SSD, an embedded memory, and a removable external memory. When the storage device 200 is an SSD, the storage device 200 may be a device that conforms to an NVMe standard. When the storage device 200 is an embedded memory or an external memory, the storage device 200 may be a device that conforms to a UFS standard or an eMMC standard. Each of the host 100 and the storage device 200 may generate a packet according to an adopted standard protocol and transmit the packet.

When the NVM 220 of the storage device 200 includes a flash memory, the flash memory may include a 2D NAND memory array or a 3D (or vertical) NAND (VNAND) memory array. As another example, the storage device 200 may include various other kinds of NVMs. For example, the storage device 200 may include magnetic RAM (MRAM), spin-transfer torque MRAM, conductive bridging RAM (CBRAM), ferroelectric RAM (FRAM), PRAM, RRAM, and various other kinds of memories.

According to example embodiments, the host controller 110 and the host memory 120 may be implemented as separate semiconductor chips. Alternatively, in some example embodiments, the host controller 110 and the host memory 120 may be integrated in the same semiconductor chip. As an example, the host controller 110 may be any one of a plurality of modules included in an application processor (AP). The AP may be implemented as a System on Chip (SoC). Further, the host memory 120 may be an embedded memory included in the AP or an NVM or memory module located outside the AP.

The host controller 110 may manage an operation of storing data (e.g., write data) of a buffer region of the host memory 120 in the NVM 220 or an operation of storing data (e.g., read data) of the NVM 220 in the buffer region.

The storage controller 210 may include a host interface 211, a memory interface 212, and a CPU 213. Further, the storage controllers 210 may further include a flash translation layer (FTL) 214, a packet manager 215, a buffer memory 216, an error correction code (ECC) engine 217, and an advanced encryption standard (AES) engine 218. The storage controllers 210 may further include a working memory (not shown) in which the FTL 214 is loaded. The CPU 213 may execute the FTL 214 to control data write and read operations on the NVM 220.

The host interface 211 may transmit and receive packets to and from the host 100. A packet transmitted from the host 100 to the host interface 211 may include a command or data to be written to the NVM 220. A packet transmitted from the host interface 211 to the host 100 may include a response to the command or data read from the NVM 220. The memory interface 212 may transmit data to be written to the NVM 220 to the NVM 220 or receive data read from the NVM 220. The memory interface 212 may be configured to comply with a standard protocol, such as Toggle or open NAND flash interface (ONFI).

The FTL 214 may perform various functions, such as an address mapping operation, a wear-leveling operation, and a garbage collection operation. The address mapping operation may be an operation of converting a logical address received from the host 100 into a physical address used to actually store data in the NVM 220. The wear-leveling operation may be a technique for reducing or preventing excessive deterioration of a specific block by allowing blocks of the NVM 220 to be more uniformly used. As an example, the wear-leveling operation may be implemented using a firmware technique that balances erase counts of physical blocks. The garbage collection operation may be a technique for ensuring usable capacity in the NVM 220 by erasing an existing block after copying valid data of the existing block to a new block.

The packet manager 215 may generate a packet according to a protocol of an interface, which consents to the host 100, or parse various types of information from the packet received from the host 100. The buffer memory 216 may temporarily store data to be written to the NVM 220 or data to be read from the NVM 220. Although the buffer memory 216 may be a component included in the storage controllers 210, the buffer memory 216 may be outside the storage controllers 210.

The ECC engine 217 may perform error detection and correction operations on read data read from the NVM 220. For example, the ECC engine 217 may generate parity bits for write data to be written to the NVM 220, and the generated parity bits may be stored in the NVM 220 together with write data. During the reading of data from the NVM 220, the ECC engine 217 may correct an error in the read data by using the parity bits read from the NVM 220 along with the read data, and output error-corrected read data.

The AES engine 218 may perform at least one of an encryption operation and a decryption operation on data input to the storage controllers 210 by using a symmetric-key algorithm.

The storage device 200 may be a solid state drive (SSD). According to example embodiments of the present disclosure, a host storage system (e.g., 10) is provided, including: a host (e.g., 100); and a storage device (200), wherein the storage device is configured to perform the method according to example embodiments of the present disclosure as described above.

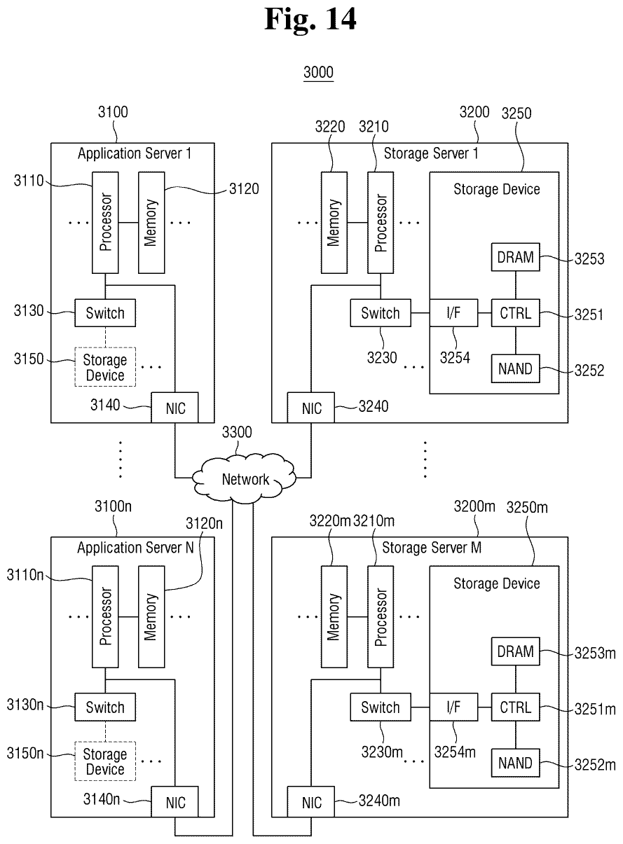

FIG. 14 is a diagram of a data center 3000 to which a memory device is applied, according to example embodiments of the present disclosure.

### Platform Portion—Server (Application/Storage)

Referring to FIG. 14, the data center 3000 may be a facility that collects various types of pieces of data and provides services and be referred to as a data storage center. The data center 3000 may be a system for operating a search engine and a database, and may be a computing system used by companies, such as banks, or government agencies. The data center 3000 may include application servers 3100 to 3100n and storage servers 3200 to 3200m. The number of application servers 3100 to 3100n and the number of storage servers 3200 to 3200m may be variously selected according to example embodiments. The number of application servers 3100 to 3100n may be different from the number of storage servers 3200 to 3200m.

The application server 3100 or the storage server 3200 may include at least one of processors 3110 and 3210 and memories 3120 and 3220. The storage server 3200 will now be described as an example. The processor 3210 may control all operations of the storage server 3200, access the memory 3220, and execute instructions and/or data loaded in the memory 3220. The memory 3220 may be a double-data-rate synchronous DRAM (DDR SDRAM), a high-bandwidth memory (HBM), a hybrid memory cube (HMC), a dual in-line memory module (DIMM), Optane DIMM, and/or a non-volatile DIMM (NVMDIMM). In some example embodiments, the numbers of processors 3210 and memories 3220 included in the storage server 3200 may be variously selected. In example embodiments, the processor 3210 and the memory 3220 may provide a processor-memory pair. In example embodiments, the number of processors 3210 may be different from the number of memories 3220. The processor 3210 may include a single-core processor or a multi-core processor. The above description of the storage server 3200 may be similarly applied to the application server 3100. In some example embodiments, the application server 3100 may not include a storage device 3150. The storage server 3200 may include at least one storage device 3250. The number of storage devices 3250 included in the storage server 3200 may be variously selected according to example embodiments.

### Platform Portion—Network

The application servers 3100 to 3100n may communicate with the storage servers 3200 to 3200m through a network 3300. The network 3300 may be implemented by using a fiber channel (FC) or Ethernet. In some example embodiments, the FC may be a medium used for relatively high-speed data transmission and use an optical switch with higher performance and/or higher availability. The storage servers 3200 to 3200m may be provided as file storages, block storages, or object storages according to an access method of the network 3300.

In example embodiments, the network 3300 may be a storage-dedicated network, such as a storage area network (SAN). For example, the SAN may be an FC-SAN, which uses an FC network and is implemented according to an FC protocol (FCP). As another example, the SAN may be an Internet protocol (IP)-SAN, which uses a transmission control protocol (TCP)/IP network and is implemented according to a SCSI over TCP/IP or Internet SCSI (iSCSI) protocol. In other example embodiments, the network 3300 may be a general network, such as a TCP/IP network. For example, the network 3300 may be implemented according to a protocol, such as FC over Ethernet (FCOE), network attached storage (NAS), and NVMe over Fabrics (NVMe-oF).

Hereinafter, the application server 3100 and the storage server 3200 will mainly be described. A description of the application server 3100 may be applied to another application server 3100n, and a description of the storage server 3200 may be applied to another storage server 3200m.

The application server 3100 may store data, which is requested by a user or a client to be stored, in one of the storage servers 3200 to 3200m through the network 3300. Also, the application server 3100 may obtain data, which is requested by the user or the client to be read, from one of the storage servers 3200 to 3200m through the network 3300. For example, the application server 3100 may be implemented as a web server or a database management system (DBMS).

The application server 3100 may access a memory 3120n or a storage device 3150n, which is included in another application server 3100n, through the network 3300. Alternatively, the application server 3100 may access memories 3220 to 3220m or storage devices 3250 to 3250m, which are included in the storage servers 3200 to 3200m, through the network 3300. Thus, the application server 3100 may perform various operations on data stored in application servers 3100 to 3100n and/or the storage servers 3200 to 3200m. For example, the application server 3100 may execute an instruction for moving or copying data between the application servers 3100 to 3100n and/or the storage servers 3200 to 3200m. In some example embodiments, the data may be moved from the storage devices 3250 to 3250m of the storage servers 3200 to 3200m to the memories 3120 to 3120n of the application servers 3100 to 3100n directly or through the memories 3220 to 3220m of the storage servers 3200 to 3200m. The data moved through the network 3300 may be data encrypted for security or privacy.

### Organic Relationship—Interface Structure/Type

The storage server 3200 will now be described as an example. An interface 3254 may provide physical connection between a processor 3210 and a controller 3251 and a physical connection between a network interface card (NIC) 3240 and the controller 3251. For example, the interface 3254 may be implemented using a direct attached storage (DAS) scheme in which the storage device 3250 is directly connected with a dedicated cable. For example, the interface 3254 may be implemented by using various interface schemes, such as ATA, SATA, e-SATA, an SCSI, SAS, PCI, PCIe, NVMe, IEEE 1394, a USB interface, an SD card interface, an MMC interface, an eMMC interface, a UFS interface, an eUFS interface, and/or a CF card interface.

The storage server 3200 may further include a switch 3230 and the NIC (Network InterConnect) 3240. The switch 3230 may selectively connect the processor 3210 to the storage device 3250 or selectively connect the NIC 3240 to the storage device 3250 via the control of the processor 3210.

In example embodiments, the NIC 3240 may include a network interface card and a network adaptor. The NIC 3240 may be connected to the network 3300 by a wired interface, a wireless interface, a Bluetooth interface, or an optical interface. The NIC 3240 may include an internal memory, a digital signal processor (DSP), and a host bus interface and be connected to the processor 3210 and/or the switch 3230 through the host bus interface. The host bus interface may be implemented as one of the above-described examples of the interface 3254. In example embodiments, the NIC 3240 may be integrated with at least one of the processor 3210, the switch 3230, and the storage device 3250.

### Organic Relationship—Interface Operation

In the storage servers 3200 to 3200m or the application servers 3100 to 3100n, a processor may transmit a command to storage devices 3150 to 3150n and 3250 to 3250m or the memories 3120 to 3120n and 3220 to 3220m and program or read data. In some example embodiments, the data may be data of which an error is corrected by an ECC engine. The data may be data on which a data bus inversion (DBI) operation or a data masking (DM) operation is performed, and may include cyclic redundancy code (CRC) information. The data may be data encrypted for security or privacy.

Storage devices 3150 to 3150n and 3250 to 3250m may transmit a control signal and a command/address signal to NAND flash memory devices 3252 to 3252m in response to a read command received from the processor. Thus, in response to data being read from the NAND flash memory devices 3252 to 3252m, a read enable (RE) signal may be input as a data output control signal, and thus, the data may be output to a DQ bus. A data strobe signal DQS may be generated using the RE signal. The command and the address signal may be latched in a page buffer depending on a rising edge or falling edge of a write enable (WE) signal.

### Product Portion—SSD Basic Operation

The controller 3251 may control all operations of the storage device 3250. In example embodiments, the controller 3251 may include SRAM. The controller 3251 may write data to the NAND flash memory device 3252 in response to a write command or read data from the NAND flash memory device 3252 in response to a read command. For example, the write command and/or the read command may be provided from the processor 3210 of the storage server 3200, the processor 3210m of another storage server 3200m, or the processors 3110 and 3110n of the application servers 3100 and 3100n. DRAM 3253 may temporarily store (or buffer) data to be written to the NAND flash memory device 3252 or data read from the NAND flash memory device 3252. Also, the DRAM 3253 may store metadata. Here, the metadata may be user data or data generated by the controller 3251 to manage the NAND flash memory device 3252. The storage device 3250 may include a secure element (SE) for security or privacy.

The storage device 200 may be an SSD. According to example embodiments of the present disclosure, a data center system (e.g., 3000) is provided, including: a plurality of application servers (3100 to 3100n); and a plurality of storage servers (e.g., 3200 to 3200m), wherein each storage server includes a storage device 200, wherein the storage device 200 is configured to perform the method according to example embodiments of the present disclosure as described above.

According to example embodiments of the present disclosure, a computer readable storage medium having a computer program stored thereon is provided, wherein the method according to example embodiments of the present disclosure described above is implemented when the computer program is executed by a processor.

According to example embodiments of the present disclosure, an electronic apparatus is provided, including: a processor; a memory storing a computer program, wherein the computer program when executed by the processor implements the method according to example embodiments of the present disclosure described above.

According to example embodiments of the present disclosure, a computer-readable storage medium storing instructions may also be provided, the instructions, when executed by at least one processor, cause the at least one processor to perform the method according to example embodiments of the present disclosure described above. Examples of computer-readable storage media herein include: read-only memory (ROM), random access programmable read-only memory (PROM), electrically erasable programmable read-only memory (EEPROM), random access memory (RAM), dynamic random access memory (DRAM), static random access memory (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blu-ray or optical disk memory, hard disk drive (HDD), solid state drive (SSD), card-based memory (such as, multimedia cards, Secure Digital (SD) cards and/or Extreme Digital (XD) cards), magnetic tapes, floppy disks, magneto-optical data storage devices, optical data storage devices, hard disks, solid state disks, and/or any other device, where the other device is configured to store the computer programs and any associated data, data files, and/or data structures in a non-transitory manner and to provide the computer programs and any associated data, data files, and/or data structures to a processor or computer, so that the processor or computer may execute the computer program. The computer program in the computer readable storage medium may run in an environment deployed in a computer device such as a terminal, client, host, agent, server, etc., and furthermore, in one example, the computer program and any associated data, data files and data structures are distributed on a networked computer system such that the computer program and any associated data, data files and data structures are stored, accessed, and/or executed in a distributed manner by one or more processors or computers.

One or more elements described above may be implemented using processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, a programmable logic unit, a microprocessor, application-specific integrated circuit (ASIC), etc. The processing circuitry may include a memory such as a volatile memory device (e.g., SRAM, DRAM, SDRAM, etc.) and/or a non-volatile memory (e.g., flash memory device, phase-change memory, ferroelectric memory device, etc.).

Other example embodiments of the present disclosure will readily come to the mind of those skilled in the art upon consideration of the specification and practice of the present disclosure disclosed herein. This application is intended to cover any variations, uses, or adaptations of the present disclosure that follow the general principles of the present disclosure and include commonly known or customary technical means in the art that are not disclosed herein. The specification and example embodiments are considered examples only, and the true scope and spirit of the present disclosure is indicated by the following claims.

1. A storage device comprising:
a memory comprising a plurality of virtual function (VF) apparatuses;
a controller configured to:
initialize a bandwidth credit of a VF queue corresponding to each VF apparatus of the plurality of VF apparatuses; and
control reading of an I/O command from the VF queue corresponding to each VF apparatus, based on the bandwidth credit and data size of the I/O command.

2. The storage device of claim 1, wherein the controller is configured to initialize the bandwidth credit of the VF queue corresponding to each VF apparatus based on a capacity ratio of each VF apparatus occupying the memory.

3. The storage device of claim 2, wherein the controller is configured to initialize the bandwidth credit of the VF queue corresponding to each VF apparatus based on the capacity ratio and a weight value for each VF apparatus.

4. The storage device of claim 1, wherein the controller is configured to:
poll each VF queue to read the I/O command from a non-empty VF queue with a current bandwidth credit greater than a threshold based on initializing the bandwidth credit of the VF queue corresponding to each VF apparatus; and
in response to the I/O command being read out of the non-empty VF queue, update the current bandwidth credit of the VF queue by subtracting the data size of the read command from the current bandwidth credit of the VF queue, and in response to the updated current bandwidth credit of the VF queue being no longer greater than the threshold, stop reading of the I/O command from the VF queue.

5. The storage device of claim 4, wherein the controller is further configured to:
in response to each VF queue being polled once, determine whether current bandwidth credits of all VF queues are all less than or equal to the threshold;
in response to the current bandwidth credits of all the VF queues all being less than or equal to the threshold, initialize the bandwidth credit of each VF queue again, otherwise continue to read the I/O command from the non-empty VF queue with the current bandwidth credit greater than the threshold.

6. The storage device of claim 5, wherein the controller is further configured to:
set the current bandwidth credit of a VF queue to the threshold if the VF queue is empty.

7. The storage device of claim 5, wherein in response to the current bandwidth credits of all the VF queues being less than or equal to the threshold, the controller is configured to initialize the bandwidth credit of each VF queue again by adding the current bandwidth credit of each VF queue to a first initialized bandwidth credit of each VF queue.

8. A method performed by a storage device, wherein the storage device comprises a memory, the memory comprising a plurality of virtual function (VF) apparatuses, the method comprising:
initializing a bandwidth credit of a VF queue corresponding to each VF apparatus of the plurality of VF apparatuses; and
controlling reading of an I/O command from the VF queue corresponding to each VF apparatus, based on the bandwidth credit and the data size of the I/O command.

9. The method of claim 8, wherein the initializing the bandwidth credit of the VF queue corresponding to each VF apparatus of the plurality of VF apparatuses comprises:
initializing the bandwidth credit of the VF queue corresponding to each VF apparatus based on a capacity ratio of each VF apparatus occupying the memory.

10. The method of claim 9, wherein the initializing the bandwidth credit of the VF queues corresponding to each VF apparatus based on the capacity ratio of each VF apparatus occupying the memory comprises: initializing the bandwidth credit of the VF queue corresponding to each VF apparatus based on the capacity ratio and a weight value for each VF apparatus.

11. The method of claim 8, wherein the controlling the reading of the I/O command from the VF queue corresponding to each VF apparatus based on the bandwidth credit and the data size of the I/O commands comprises:
polling each VF queue to read the I/O command from a non-empty VF queue with a current bandwidth credit greater than a threshold based on initializing the bandwidth credit of the VF queue corresponding to each VF apparatus; and
in response to the I/O command being read out of the non-empty VF queue, updating the current bandwidth credit of the VF queue by subtracting the data size of the read command from the current bandwidth credit of the VF queue, and in response to the updated current bandwidth credit of the VF queue being no longer greater than the threshold, stopping reading of the I/O command from the VF queue.

12. The method of claim 11, further comprising:
in response to each VF queue being polled once, determine whether current bandwidth credits of all VF queues are all less than or equal to the threshold;
in response to the current bandwidth credits of all the VF queues all being less than or equal to the threshold, initializing the bandwidth credit of each VF queue again, otherwise continuing to read I/O commands from non-empty VF queues with the current bandwidth credit greater than the threshold.

13. The method of claim 12, further comprising:
setting the current bandwidth credit of a VF queue to the threshold if the VF queue is empty.

14. The method of claim 12, wherein the initializing the bandwidth credit of each VF queue again comprises: initializing the bandwidth credit of each VF queue again by adding the current bandwidth credit of each VF queue to a first initialized bandwidth credit of each VF queue.

15. A storage system comprising:
a main processor;
a main memory; and
a storage device,
wherein the storage device is configured to perform the method according to claim 8.

16. (canceled)

17. (canceled)

18. (canceled)

19. (canceled)
